(19) United States
(12) Patent Application Publication
(10) Pub. No.: US 2005/0086588 A1
(43) Pub. Date: Apr. 21, 2005

(54) Method, system and apparatus for creating a workflow process

(76) Inventors: Chad Allan McGregor, Seattle, WA (US); Sadiq Ahmad M. Bekinalker, Redmond, WA (US); John O. Buchanan, Snohomish, WA (US); Michael Wills, Seattle, WA (US); Robert Webber, Sammamish, WA (US)

Correspondence Address: MILLER NASH LLP, 4400 TWO UNION SQUARE, 601 UNION STREET, SEATTLE, WA, 98101-2352, US

(21) Appl. No.: 10/688,832

(22) Filed: Oct. 17, 2003

(51) Int. Cl. G06F 15/00

(52) U.S. Cl. 715/505

(57) ABSTRACT

The present invention relates to the creation of a custom workflow process, and more specifically, to a system, method and article of manufacture for creating a custom workflow process accessible over a network. The invention enables a user, system analyst or end user with no previous computer programming or computer developing skills, to define, create and execute a workflow process.

### BACKGROUND OF INVENTION

1. Field of Invention

The present invention relates to the creation of a custom workflow process, and more specifically, to a system, method and article of manufacture for creating a custom workflow process accessible over a network.

2. Background

The automation of a process, during which documents, information or tasks (“data”) are transmitted in a way that is governed by rules or procedures, is often referred to as a “workflow.”

In a workflow, data may be assigned to individuals based on the characteristics of each individual. For example, if the workflow process takes place in a business setting, a supervisor may assign different data to different employees based on each employee's knowledge, experience and resources.

The definition and execution of a workflow can occur using a plurality of mediums, including but not limited to, pen, paper or typewriter. However, with the advent of computers and related technologies, the definition and execution of a workflow has expanded from a paper-based workflow to a workflow automated by a computing device.

Computer-based workflows may be defined and executed using a custom-developed workflow process program. However, custom-developed workflow process programs are limiting for several reasons. First, computer specialists must be hired to custom develop the workflow process program on an individual's computing device. This can be a very costly and time-consuming process. Further, an individual's computing device is usually located at a single geographic site. A workflow may transmit data between a group or network of individuals. Because the custom-developed program is located on an individual's computing device at a single geographic site, other individuals in a group or network who do not have a custom-developed program installed on a computing device will be prevented from participating in the workflow process until the custom developed program is installed on their computing device. Second, custom-developed workflow process programs are often static, and unable to be manipulated, reconfigured or further developed by an individual to include changes to, or further definition of, the workflow process. An individual may have to re-hire the computer specialist to manipulate, reconfigure or further develop the custom program so that the workflow process executes according to the participant's definition. Manipulating, reconfiguring or further developing the custom program can be a time-consuming, costly and inconvenient process.

An individual may also purchase pre-developed computer-based workflow process software. However, pre-developed software is limiting for several reasons. First, pre-developed software provides workflow processes comprised of generic data for use by an individual in a computer-based workflow process. The generic data may not provide the definition and execution of a workflow process required by an individual to execute a desired process. Second, most businesses prefer to present data having a specific format (i.e. user interface, aesthetic appearance, logos, designs) generally used by the business. Pre-developed software may not contain data that is formatted in accordance with a business's specific format.

### BRIEF SUMMARY OF THE INVENTION

Unlike custom developed workflow process programs or pre-developed computer based workflow process software, the present invention relates to the creation of a custom workflow process, and more specifically, to a system, method and apparatus for creating a custom workflow process accessible over a network. The present invention enables a user, system analyst or end user with no previous computer programming or computer developing skills, to develop a custom workflow process.

The present invention also includes a method for creating a workflow process, including accessing a business logic editor located on a master center, presenting at least two action object icons on a user interface, accessing a canvas screen, selecting a first of the at least two action object icons, moving the first of at least two action object icon to the canvas screen, defining properties for the first of at least two action object icons, moving a second of the at least two action object icons to the canvas screen, defining properties for the second of at least two action object icons; and linking the at least two action object icons to create a workflow process.

In an alternate embodiment for creating a workflow process, the present invention includes a method and system for creating a workflow process, including receiving an HTTP request, the HTTP request being received from a network; providing access to a screen and at least two action object icons; and allowing at least two of the at least two action object icons to be moved to the screen and to be linked in a workflow process.

The present invention further includes a method for executing a workflow process, including inputting a request to access a workflow process to a master center, accessing the requested workflow process containing at least two action object icons, executing a first action object icon of the workflow process, saving the executed first action object icon on the master center, determining a second action object icon of the workflow process, executing a second action object icon of the workflow process, saving the executed second action object icon on the master center; and continuing to execute the action object icons of the workflow process until the workflow process is complete.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic overview of an exemplary system for creating a custom workflow process and for accessing the custom workflow process over a network.

FIG. 2 is a schematic diagram of an exemplary client computer system.

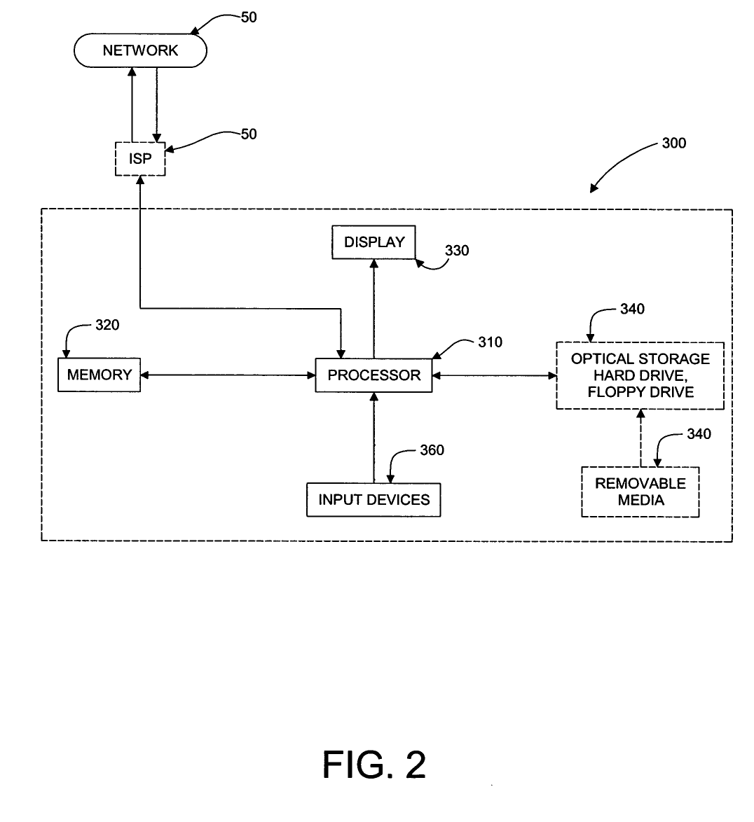

FIG. 3 is a flow chart showing an overview of the process for creating custom workflow process files for inputting into a custom workflow process.

FIGS. 4 and 5 show exemplary code fragments of defined data records.

FIG. 6 shows an exemplary code fragment of a data file.

FIG. 7 shows an exemplary action object icon which may access the exemplary data file shown in FIG. 6.

FIG. 8 is a flow chart showing an overview of the process for creating a custom workflow process based on previously created custom workflow process files.

FIGS. 9-13 show the creation of a custom workflow process.

FIG. 14 is a flow chart showing the execution of a custom workflow process.

### DETAILED DESCRIPTION OF THE INVENTION

The present invention relates to the creation of a custom workflow process, and more specifically, to a system, method and apparatus for creating a custom workflow process 10 accessible over a network 50. The present invention enables an entity 20, system analyst 40 or an end user 30 with no previous computer programming or computer developing skills, to develop a custom workflow process 10. Further, the present invention provides a system, method and apparatus for creating a custom workflow process 10 having a user interface format that presents the documents, information or tasks of the workflow process 10 in the user interface format desired by the entity 20, end user 30 or system analyst 40.

For purposes of the present invention, an “entity” 20 is: (1) at least one person; (2) at least one client computer 300; or (3) at least one person and at least one client computer 300. A “client computer” 300 is a processing device such as a computer or hand-held palm device, a group of processing devices, or a network 50 of processing devices. An “end user” 30 is an entity 20 performing a workflow process 10 of the present invention or an entity 20 entering data into a form subject to a workflow process 10. A “system analyst” 40 is an entity 30 that creates or defines any custom workflow process 10, data record, data file, form, action object icon or user interface as described in the present invention. A “network” 50 may be a Wide Area Network (“WAN”), Local Area Network (“LAN”), wireless network, Internet, or any other network such as the Internet.

Any specific examples set forth in this detailed description are exemplary and are not intended to limit the subject matter, geographic site, entities 20, client computers 300, end users 30, system analysts 40, or network 50 with which the present invention may be used. Further, this detailed description is not intended to limit the number of entities 20, system analysts 40, or end users 30 who may use the present invention.

A. System Overview and Configuration

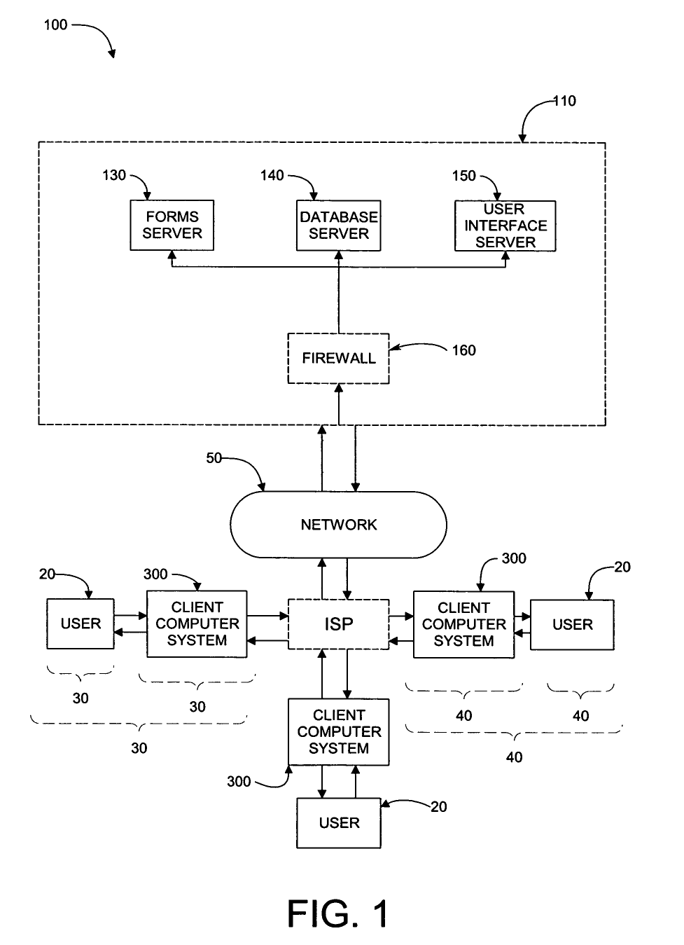

FIG. 1 illustrates an exemplary embodiment 100 of a system overview of the data flow for a request/response for accessing a workflow process 10, which may optionally be associated with a domain name resolved into an Internet Protocol (“IP”) address or an IP address directly provided by an entity 20, end user 30, or system analyst 40.

FIG. 1 shows a master center 110 which includes elements such as an optional firewall 160 and a database server 140, a forms server 130 and a user interface server 150. For purposes of this invention, the database server 140, forms server 130 and user interface server 150 may be physically located on separate platforms. Alternatively, the database server 140, forms server 130 and user interface server 150 may be physically combined on one platform. Still a further option, the forms server 130 and user interface server 150 may be physically located together on a platform separate from the database server 140. Or, the user interface server 150 and database server 140 may be physically located together on a platform separate from the forms server 130. Finally, the forms server 130 and database server 140 may be physically located on a platform separate from the user interface server 150. As is evident from the foregoing examples, the physical and logical location of the forms server 130, database server 140, and user interface server 150 is irrelevant for purposes of performing the present invention. While this written description will refer to the master center 110, it is to be understood that the master center 110 is comprised of the forms server 130, database server 140, and user interface server 150 separately or in combination, and that any transmission to or from the master center 110 may occur from the forms server 130, database server 140, and user interface server 150 separately, or in any combination set forth above.

The forms server 130 accepts submissions from the user interface server 150; saves submitted data in the database server 140; and determines the sequence in which each action object 455 of a requested workflow process 10 is performed by accessing a workflow process definition at the database server 140, forms server 130, or user interface server 150.

The forms server further includes a business logic editor 135. The business logic editor 135 allows a system analyst 40 with no previous computer programming or software development experience to create a custom workflow process 10. Using the principles of the present invention, a system analyst 40 may access the business logic editor 135 and create a workflow process 10 using a network 50. The business logic editor 135 is a thin client application that is accessible by a system analyst 40 who has satisfied the optional security procedures. Optional security procedures may include a password authentication system wherein specific passwords are linked to previously defined access rights.

The user interface server 150 sends submitted data to the forms server 130. The user interface server 150 provides the functionality to interpret, validate and format data to be submitted to the forms server 130 and to be returned over a network 50; and provides logic that displays forms 445 and action object icons 455.

The database server 140 provides database tables for storing data records 415, data files 425, action object icons 455, forms 445 and workflow processes 10. The database server 140 further saves data entered by an end user 30. The data may be stored in the database server 140 in a database table that is specifically created by the database server 140 for the data entered by the end user 30. To further protect the data contained in the master center 110, the data may be backed up in accordance with standard backup procedures commonly known and used in the industry.

The optional firewall 160 provides security to the master center 110 by limiting network traffic to only allow TCP/IP ports and addresses. For purposes of the present invention, any of the servers—the forms server 130, database server 140, and user interface server 150—may be located either inside or outside the optional firewall 160.

Data flows between the master center 110 and an end user 30 or system analyst 40. In an optional embodiment, data flows between the master center 110 and the end user 30 or system analyst 40 through a network 50. If the network 50 is the Internet, the data flow may occur using an Internet Service Provider (“ISP”). While the ISP may be an Internet Access Provider or any other company, individual or device capable of transmitting data, the ISP may be a client computer 300 or the client computer 300 may be an ISP. If the network 50 is a LAN, the data may flow between the master center 110 and the end user 30 or system analyst 40 through the network 50 using conventional LAN routing systems and apparatuses. As is evident from the foregoing examples, the type of routing system used in the present invention is dependent on the network 50.

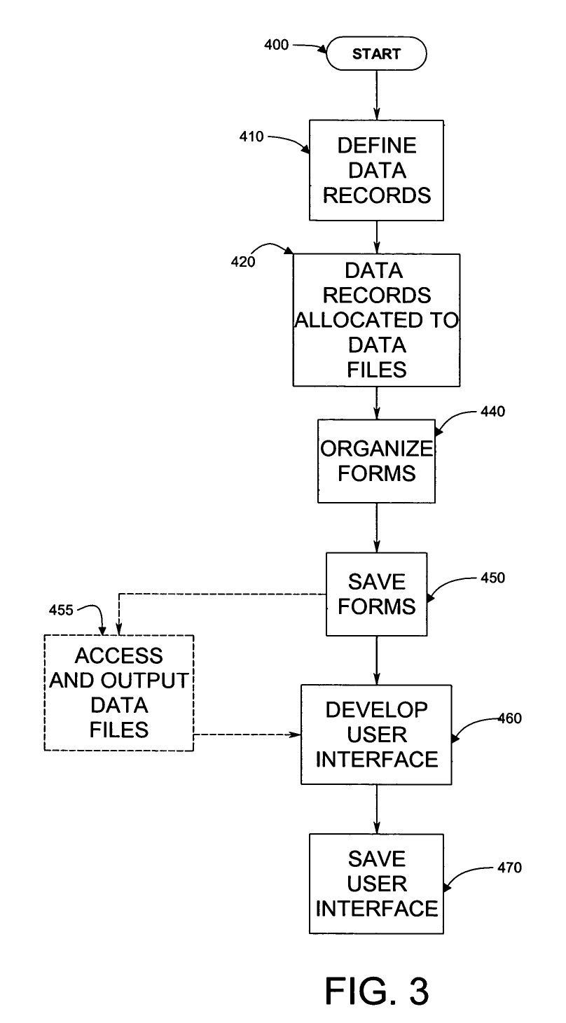

FIG. 3 illustrates an exemplary client computer system 300 including components of a processing device suitable for accessing a workflow process 10 of the present invention. The client computer system 300 is exemplary and is not intended to limit the type of client computing system 300 which may be used with the present invention. In FIG. 3, a processor 310 is shown coupled bi-directionally to a memory 320 that encompasses read only memory (ROM) and random access memory (RAM). ROM is typically used for storing processor specific machine code necessary to bootup the computer comprising client computer 300, to enable input and output functions, and to carry out other basic aspects of its operation. Processor 310 is coupled to a display 330 on which the visualization of the HTML response discussed above and below may be presented to a system analyst 40 or an end user 30. Often, programs and data are retained in a nonvolatile memory media 340 that may be accessed by a compact disk read only memory (CD-ROM) drive, compact disk-read/write memory (CD-R/W) drive, optical drive, digital versatile disc, also referred to as a digital video disc, (DVD) drive, hard drive, tape drive, and floppy disk drive, all generally indicated by reference numeral 340 in FIG. 3. If the network 50 is the Internet, an ISP may couple the processor 310 to the network 50.

A client computer 300 accesses a requested workflow process 10 of the present invention via a network 50. As previously stated, if the network 50 is the Internet, it is preferred the network 50 uses an ISP which assists in transmitting the flow of data between the client computer 300 and the master center 110. Control of the client computer 300 and selection of options and input of data are implemented using input devices 360, which typically include a keyboard and a pointing device such as a mouse (neither separately shown). Further details of system for the client computer 300 and of the processing device 310 comprising it are not illustrated, since they are generally well known to those of ordinary skill in the art. Additionally, although not shown, computer systems for the master center 110 could be configured in substantially the same way as the computer system for the client computer 300 illustrated here, albeit in different other ways.

To access a workflow process 10 using the system shown in FIG. 1, where the network 50 is the Internet, an end user 30 [clerk] or system analyst 40 manually inputs, via the input device 360, an HTTP request to the client computer 300. The client computer's 300 server sends the HTTP request to an ISP for access to resources associated with an IP address that may be either resolved or directly provided to the client computer 300. The client computer 300 may connect to the local ISP through a telephone modem, cable modem, DSL, Wi-fi technology, and/or satellite connection. The local ISP usually provides a local domain name system server that communicates with other servers on the network 50 for resolving a domain name request into an IP address when the client computer 300 provides a domain name for accessing resources.

The client computer 300 server sends the HTTP request over a network 50, to the master center 110. Preferably, the master center 110 is associated with the requested domain name or IP address. The master center 110 may provide access to the requested workflow process 10 in a number of ways. In a first exemplary embodiment, the master center 110 provides access to the requested workflow process 10 in an HTTP response sent by the master center 110 over the network 50 to the client computer 300 IP address at the ISP. The client computer 300 accesses the requested workflow process 10 in the HTTP response received from the ISP. In a second exemplary embodiment, the master center 110 accesses the requested workflow process 10, converts the workflow process 10 from an XML to an HTTP format, and then sends the requested workflow process 10 in an HTTP response over the network 50 to the client computer 300 IP address at the ISP.

B. Workflow Process

1. Definition

FIG. 3 is a flow chart illustrating an overview of the main logic for defining a workflow process 10 using a business logic editor 135. As discussed below, the workflow process 10 may be defined using a business logic editor 135 contained in the forms server 130.

Moving from a start block 400, the logic steps to a block where data records are defined 410. This process begins with the gathering of data. The end user 30 or system analyst 40 may gather any data that they would like to have included in or entered into a workflow process 10. Alternately, the data may have been previously gathered and located at the master center 110. Preferably, the data is generic data which will work in any workflow process 10 used by the end user 30. The data may also be specific to a business or industry. For example, if the workflow process 10 is defined for the medical industry, the data to be included or entered into the workflow process 10 could include patient information such as name, address, medical history, treating doctor; patient consents; medical information; physician information; and any other information or data related to the medical industry. If the workflow process 10 is defined for the banking industry, the data to be included or entered into the workflow process 10 may include account holder names, addresses, account numbers, banking institutions, account balances, loan information, banking transactions, and any other data or information relating to the banking industry. As is evident, any data may be gathered for use in any given workflow process 10, and therefore, the examples or data contained herein are not intended to limit the type of data that may be gathered in accordance with the present invention.

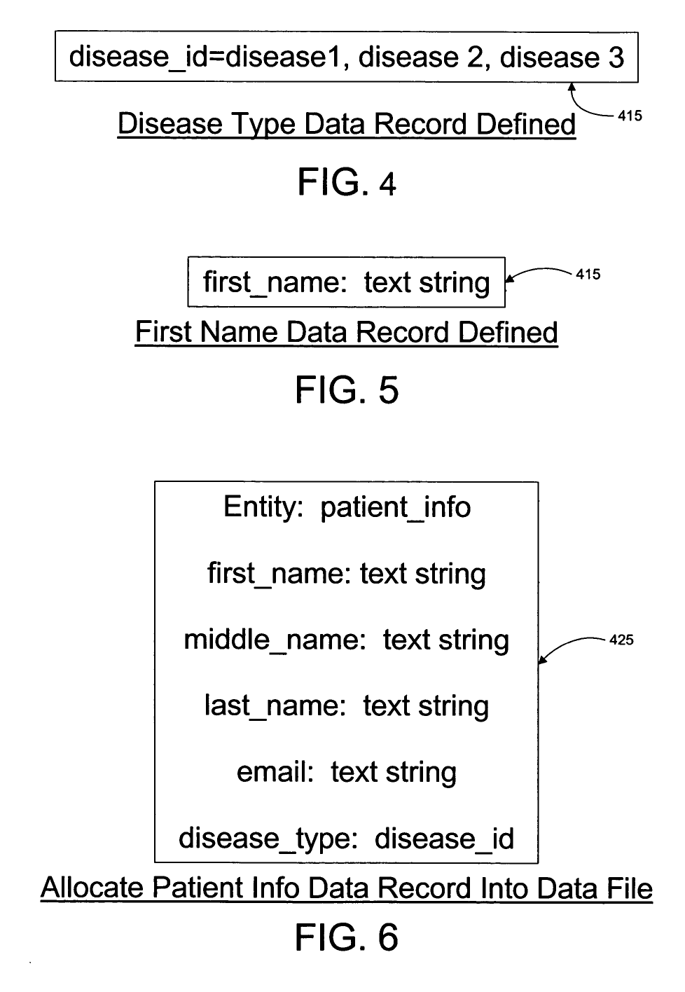

After gathering the data, the system analyst 40 defines the data records based on the gathered data. Specifically, the system analyst 40 reviews the gathered data, which for example, includes data for first name, last name, and middle name. To define the data for first name, last name, and middle name, the system analyst 40 names the gathered data and defines the gathered data in at least one data record 415. Continuing with the name example, the system analyst 40 may name the gathered data—first name, last name, and middle name—as “name data.” This means that an end user 30 accessing a data record 415 defined as “name data” would access data for first name, last name, and middle name. Any time an end user 30 or system analyst 40 wants to input information into a workflow process 10, “name data” will allow the end user 30 or system analyst 40 to input information into the workflow process 10 which relates to the first name, last name, and middle name. FIG. 4 illustrates another example of defining a data record 415 for “disease data,” which includes gathered data for disease 1, disease 2, and disease 3. Any time an end user 30 or system analyst 40 wants to input information into a workflow process 10, “disease data” will allow the end user 30 or system analyst 40 to input information into the workflow process 10 which relates to the three different disease types. The defining of name data creates a data record 415. The defining of disease data creates a data record 415. As is evident, the number of data records 415 created by a system analyst 40 for the present invention is limited only by the amount of data gathered by the end user 30 or system analyst 40. Any gathered data may be defined as a data record 415. Preferably, all data gathered in a data record 425 is in an XML representation. XML is short for “extensible markup language,” a language commonly known in the computing industry and used as the primary language for designing web documents. XML allows for the customization, transmission, definition, validation, and interpretation of documents on a network 50.

In defining the data records 415, the system analyst 40 may use user interface data selection techniques to control how inputtable data, defined in a data record 415, is input by an end user 30. For example, FIG. 5 shows a first exemplary embodiment of a user interface data selection technique, in which the first name data is developed as an inputtable field in the form of a text string. In performing a workflow process 10, the end user 30 can input first name data into the inputtable field using an input device 360. All data in the system, including input data, is as an XML representation. In a second exemplary embodiment of a user interface data selection technique, the data record 415 is developed as a plurality of radio button values. Radio button values are commonly known in the industry and are inputtable fields which provide an end user 30 with each piece of gathered data of a data record 415 as an inputtable selection. The end user 30 may select one, or all, of the gathered data by using an input device 360 to select the inputtable field corresponding to one, or all, of the gathered data. For example, a “title data” record 415 may include gathered and defined data such as “Mr.”, “Mrs.”, and “Ms.” If the system analyst 40 develops the “title data” record 415 as a plurality of radio button values, the end user 30 may, using an input device 360, select an inputtable field corresponding to one piece of gathered data which corresponds to the title the end user 30 wishes to select. For example, if the end user 30 is entering data into a workflow process 10 for a male medical patient, the end user 30 may use an input device 360 to select the inputtable field corresponding to “Mr.” In a third exemplary embodiment, the gathered data contained in a data record 415 may be developed as a plurality of drop down menus. Drop down menus are commonly known in the industry and are selectable fields which allow an end user 30 to use an input device 360 to select a data record 415. The selected data record displays gathered data for that data record 415. The end user 30 then selects the data from the displayed data. For example, using the drop down menus embodiment, the end user 30 may select the “title data” record 415 from a drop down menu. The end user 30 would be confronted with data corresponding to “Mr.”, “Mrs.”, or “Ms.” The end user 30, using an input device 360, would select on the data record corresponding to the appropriate title for the end user's 30 subject.

The defined data records 415 may be saved at the master center 110. A data record 415 may be identified by a name, size, and date of creation/modification of the defined data record 415. Optionally, a data record 415 table may be created at the location where the data records 415 are saved.

Moving to block 420, the logic steps to a block where data records 415 are allocated to data files 425. To allocate the data records 415 to data files 425, the system analyst 40 accesses the data records 415. If the data records 415 have been saved, the system analyst 40 may access the data records 415 saved at the master center 110. The system analyst 40 selects data records 415. Which data records 415 are selected is irrelevant for purposes of the invention. The system analyst 40 may select data records 415 that the end user 30 will use in a workflow process 10. Alternatively, the system analyst 40 may select the data records 415 that will be used in a workflow process 10. For purposes of the invention, it is only important to know that the data records 415 are selected from the location in the master center 110 where they have been saved.

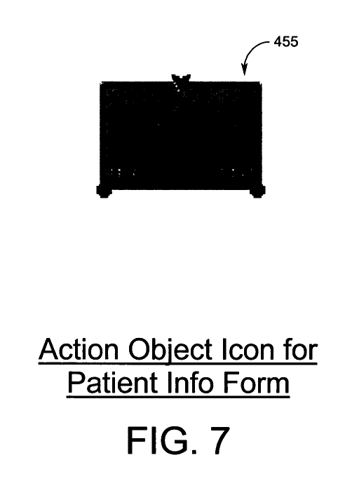

The system analyst 40 creates data files 425 incorporating at least one data record 415. Preferably, each data file 425 is created as an XML representation of a form. For example, FIG. 6 shows a data file 425 which has been named a “patient information file” 425. The patient information file 425 includes data records 415 for name data (first name, last name, middle name), email data (home email address, work email address), and disease type data. The data records 415 contained in a data file 425 need not be presented in any order.

The system analyst 40 saves the data files 425 at the master center 110. The representations of the data files 425 may be identified by a name, size, and date of creation/modification.

Moving to block 440, the data files 425 are organized into forms 445 containing a format desired by either the end user 30 or system analyst 40. Preferably, an end user 30 will want to control the format of the workflow process 10 that is presented to the end user 30 or other end users 30. A system analyst 40, therefore, is optimally presented with a method for formatting data files 425 so that they are presented in forms 445, preferably in an XML format, which contain a desired format, user interface, aesthetic appearance, logos, style, or other features.

The system analyst may either directly access the forms 445 wherever they have been saved at the master center 110. Alternatively, the system analyst 40 may be provided with web services call and security measures recognized by the master center 110. The web services call measures allow the system analyst 40 to develop software to access the data records 415 and data files 425 over a network 50. Specifically, the web services call provides the system analyst 40 with information as to how to invoke the master center 110 through web services call (e.g., how to submit a form, etc.). Further, the web services method calls include text definitions for all interface methods or functions (e.g. submitform, GetData).

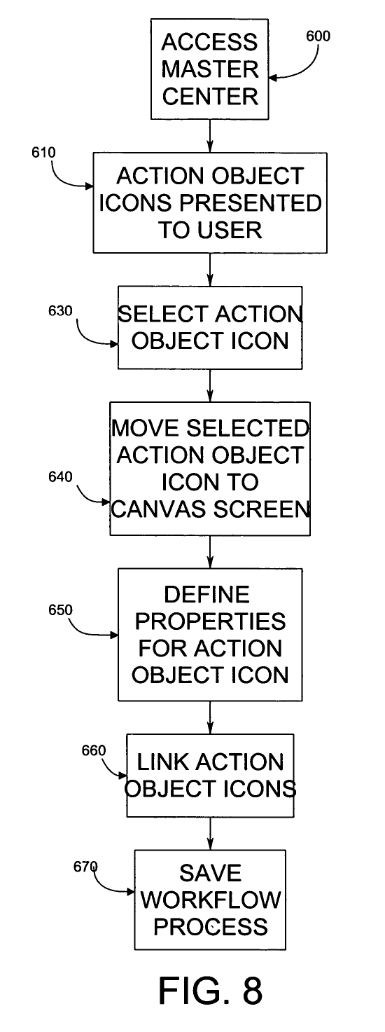

Moving to block 450, each of the defined forms 445 are saved at the master center 110. The system analyst 40 then selects action object icons 455. The action object icons 455 provide a graphical interface for allowing a system analyst 40 to create a workflow process 10. The action object icons 455 represent properties that determine how a form 445 or forms 445 are treated in a workflow process. FIG. 7 shows an action object icon 455, which when accessed, sets forth the properties for treatment of a form 445. The action object icons 455 may be accessed using an input device 360 such as a mouse. The action object icons 455 may be saved at the master center 110 and identified by a name, size, and date of creation/modification.

In an optional embodiment, the logic flows to a block 455 where at least one data file 425 may be accessed and output. After accessing the at least one data file 425, the logic flows to 470, where an XML representation of each accessed data file 425 may be output. The output XML representation of the data files 425 provides the structure and types of data contained in each data file 425.

At block 460, the system analyst 40 may independently develop a web based user interface 465. The user interface 465 will be viewed by end users 30 accessing a workflow process 10 over a network 50. The web based user interface 465 can be developed using a programming or development language independent from the programming or development language previously used by a system analyst 40 to define the data records 415, data files 425, and to develop components of the master center 110. For example, the web based user interface 465 may be written in Java® (owned by Sun Microsystems, Inc., a Delaware corporation), even though the forms server 130, database server 140, business logic editor 135, and other components of the master center 110 were developed and executed in the C# language under Microsoft.NET.

Moving to block 470, the web based user interface 465 developed by the system analyst 40 may be saved at the master center 110.

2. Creation

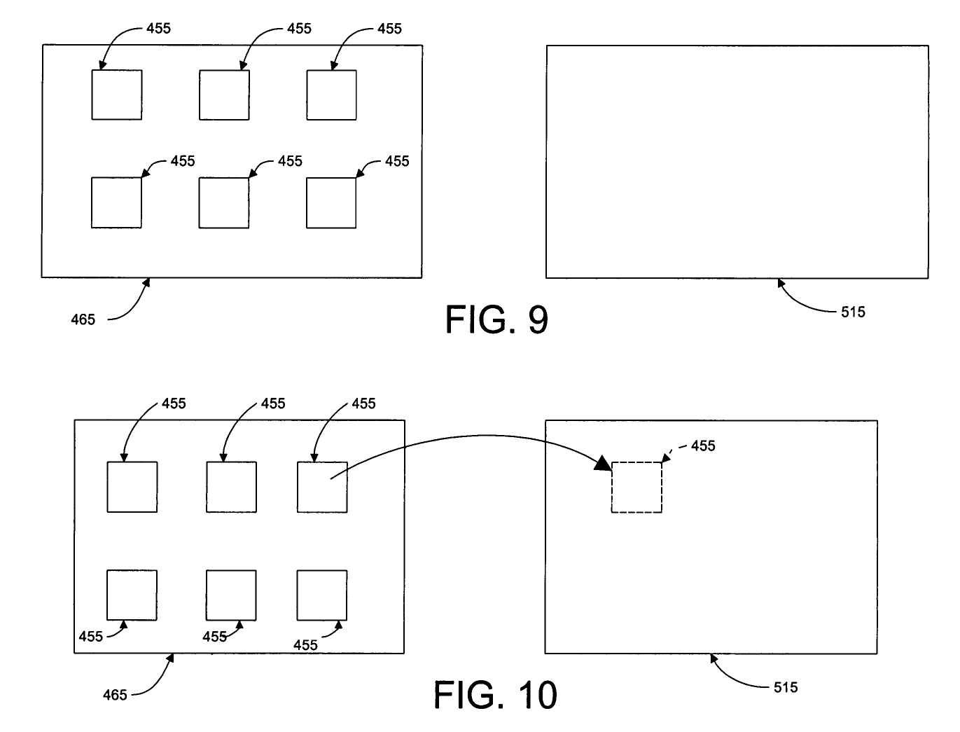

FIG. 8 is a flow chart illustrating an overview of the main logic for allowing a system analyst 40 to access the business logic editor 135 and create a customized workflow process 10 using previously defined forms 445 and using action object icons 455 to determine the workflow process 10. By creating or modifying the properties of at least two action object icons 455, a system analyst 40 lacking conventional programming experience can create a customized workflow process 10 using previously defined forms 445.

Moving to block 600, a system analyst 40 accesses the master center 110 by manually inputting, via an input device 360, a request. If the network 50 is the Internet, the request may be an HTTP request. If this is the case, the client computer's 300 server sends the HTTP request to the local ISP. After connecting to the local ISP, the client computer 300 server sends the HTTP request over a network 50 to the master center 110.

In a first embodiment, the system analyst 40 accesses the master center 110, and specifically, the business logic editor 135. In a second embodiment, the system analyst 40 accesses the master center 110 and is directed to a screen having a login interface. If the network 50 is the Internet, after entering an HTTP request, the system analyst 40 is directed to a web address where the system analyst 40 is confronted with a web based user interface 465 screen having a login interface. The system analyst 40 is required to input login information, such as a user name or password, or otherwise activate a secure connection. The secure connection may be a Virtual Private Network (VPN), Internet or local network. If the system analyst 40 inputs the required login information or activates the secure connection, the system analyst 40 accesses the master center 110, and specifically, the business logic editor 135.

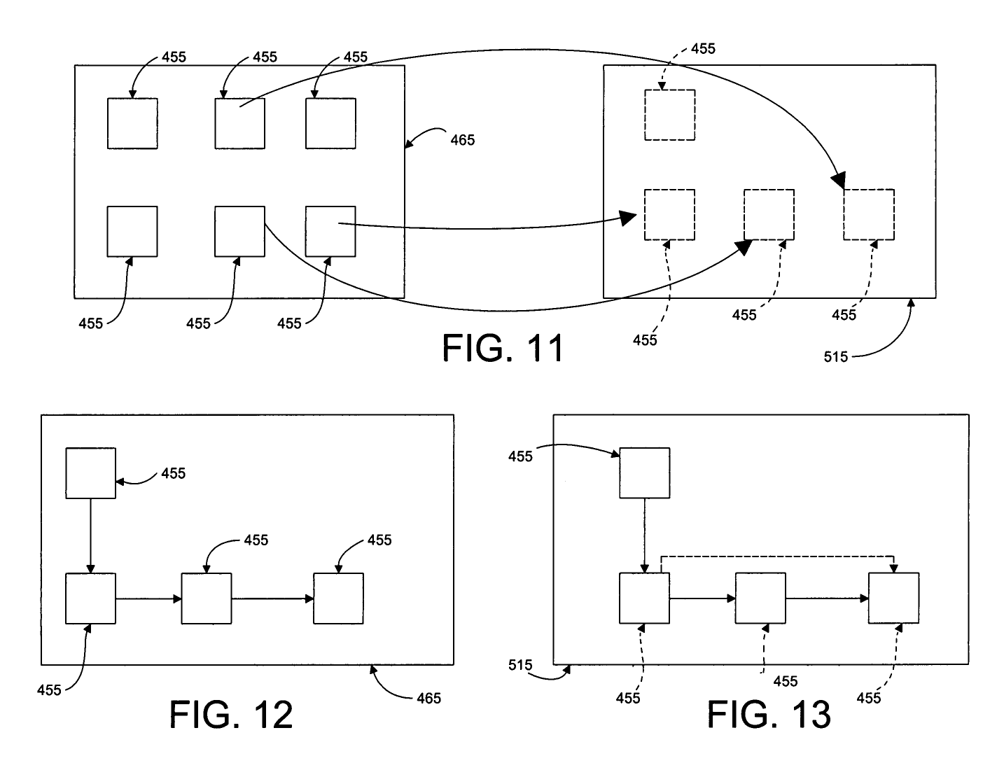

Proceeding to block 610, and as shown in FIG. 9, upon accessing the master center 110 and specifically, the business logic editor 135, the saved action object icons 455 are presented on a user interface such as a screen 465. There may also be presented a blank user interface such as a “canvas” screen 515. Which action object icons 455 are presented on the screen 465 may be determined by the level of the system analyst's 40 access to the system. For example, the password entered by a system analyst 40 may provide clearance for only certain action object icons 455 saved at the master center 110. Alternatively, every action object icon 455 at the master center 110 is presented to the system analyst 40 for creating a custom workflow process 10.

The “canvas” screen 515 provides a user interface and developing environment wherein the system analyst 40 may prepare and customize a workflow process 10. Preferably, the canvas screen 515 and the screen 465 containing the plurality of action object icons 455 are presented so that the system analyst 40 can view both the screen 465 and the “canvas” screen 515 simultaneously on a computing system.

The system analyst 40 reviews the action object icons 455 contained on screen 465. Again, the action object icons 455 represent how the form 445 is treated throughout a workflow process 10. The forms 445 consist of previously defined data files 425 which have been formatted. In step 630, the system analyst 40 selects an action object icon 455 that the system analyst 40 desires to use in the workflow process 10. As shown in FIG. 10, at block 640, the system analyst 40 moves the selected action object icon 455 to the canvas screen 515 using an input device 360. The system analyst 40 may select and move any number of action object icons 455. To create a workflow process 10, however, the system analyst 40 must select and move at least two action object icons 455 to the canvas screen 515. FIG. 11 shows a canvas screen 515 where the system analyst 40 has selected and moved four action object icons 455.

At block 650, the system analyst 40 defines the properties for an action object icon 455. After moving the selected action object icon 455 to the canvas screen 515, a dialog box opens for that action object icon 455. A dialog box for an action object icon 455 provides input capabilities for the system analyst 40 to define the workflow properties that will be allocated to that action object icon 455, or more specifically, the properties that will be allocated to the action object icon 455, or more specifically, the processes that will be applied to the underlying form 445.

In defining the properties of the action object icon 455, the system analyst 40 may define form related functions to the action object icon 455. Form related functions may include, but are not limited to: (i) instructing the action object icon 455 to save data entered into the form 445 in the database server 140, forms server 130 or user interface server 150; (ii) instructing the action object icon 455 to check for combinations of data on the form 445; (iii) initiate emails to an end user 30 based on data entered into the form 445; (iv) generate correspondence to an end user 30 based on data entered into the form 445; or (v) generate audit information.

In defining the properties, the system analyst 40 may define how a form is processed. For example, by defining the destination for a form 445 subject to the workflow process 10, a system analyst 40 creates a workflow process 10 that may be used over a network 50. The system analyst 40 may define the properties of action object icons 455 so that a form 445 or forms 445 are transmitted to end users 30 located anywhere in the world. In assigning a destination for a form 445, the destination need not be limited to one end user 30. Instead, and for example, a workflow process 10 prepared in accordance with the present invention could link end users 30 from France, Asia, and the U.S., in the same workflow process 10 by providing that the destinations for action object icons 455 are for the end users 30 in each country. To define the destination for a form 445, the system analyst 40 defines the action object icon 455 so that it links an email address or IP address for a desired end user 30 to the desired destination. The email address or IP address for an end user 30 may be input directly by the end user 30 or system analyst 40, or taken from data entered into a form 445.

Moving to the next block 660, the system analyst 40 links the selected and defined action object icons 455 in a workflow process 10. The business logic editor 135 is a thin-client application which allows the system analyst 40 to link together action object icons 455 using an input device 360. By linking at least two action object icons 455, the end user 30 determines how the workflow process 10 will proceed by creating logic whereby the performance of a first action object icon 455 will be followed by a subsequent, second action object icon 455 which is linked in some manner to the first action object icon 455. The linking of at least two action object icons 455 represents the flow of execution of the workflow process 10 created by the system analyst 40.

In linking at least two action object icons 455, the system analyst 40 defines how the workflow process 10 will be executed. In a first embodiment, the workflow process 10 may be a single flow. FIG. 12 shows a workflow process 10 where the workflow process 10 is linked as a single flow. A single flow workflow process 10 means that, regardless of the data provided by an end user 30, the workflow process 10 continues as defined by the system analyst 40; there is only one workflow process 10 path. In a second embodiment, shown in FIG. 13, the workflow process 10 is linked in a plurality of workflow process 10 paths. Based upon an end user's 30 input, the workflow process 10 executes down one of the plurality of workflow process 10 paths. For example, in a workflow process 10 related to patient medication, the type of disease that the patient has been diagnosed with is data imperative to determining the type of medication supplied to the patient. Further, a patient's response to the medication is data imperative to determining whether a specific type of medication should be continued to be supplied to a patient. Also, diseases generally include symptoms. To diagnose if and what type of disease a patient may have, it may be important to collect data from the patient relating to the patient's symptoms. As is obvious from the foregoing, it is unnecessary and redundant to use a workflow process 10 which collects and provides data relating to each disease and each medication of the workflow process 10. Instead, the workflow process 10 related to patient medication may incorporate several workflow process 10 paths, with the direction of the workflow process 10 being determined by the data input by the end user 30 regarding the type of disease, the patient's response to medication, and symptoms of the patient.

In an optional embodiment, the canvas screen 515 provides views whereby a system analyst 40 can select the page layout by incrementing and decrementing vertical and horizontal page indicators. The canvas screen 515 adjusts the view according to the number of pages selected as rows and columns. Dotted lines are displayed to show the corresponding page boundaries. The page layout clearly shows how the work flow sections will appear on printed pages. A system analyst 40 or end user 30 may drag and drop sections of a workflow to rearrange page print assignments.

At the next block 670, after creating a customized workflow process 10, the system analyst 40 may save the workflow process 10 at the master center 110. Again, it is preferred that the workflow process 10 be saved in an XML format.

3. Execution

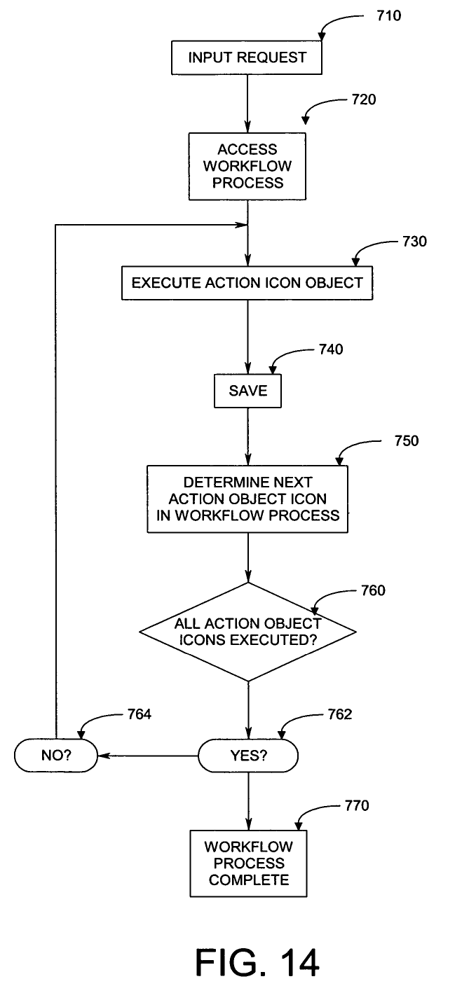

FIG. 14 details how an end user 30 executes a workflow process 10 in accordance with the principles of the present invention. At step 710, the end user 30 accesses a workflow process 10 by inputting a request. If the network 50 is the Internet, the request may be an HTTP request and the HTTP request may be sent to a local ISP for accessing a workflow process 10 associated with a domain name resolved into an IP address or directly provided to the end user 30. The HTTP request is preferably sent over a network 50 to the master center 110. The master center 110 is preferably associated with the requested domain name or IP address.

The next step, shown at 720, is accessing the workflow process 10 at the master center 110. In a first exemplary embodiment, the network 50 is the Internet. The forms server 130, database server 140 or user interface server 150 accesses the workflow processes 10 saved at the master center 110. The master center 110 provides access to the requested workflow process 10 to the end user 30 in an HTTP response that is sent by the master center 110 over the network 50 to the end user's 30 IP address at the ISP. The end user 30 may access the requested workflow process 10 in the HTTP response received from the ISP. In a second exemplary embodiment, the network 50 is a LAN and requests and access to requested workflow processes 10 are transmitted to the end user 30 through an internal routing system.

At step 730, the end user 30 inputs the data required by a form 445, the form 445 being part of the workflow process 10. The form 445 is then submitted in accordance with the properties previously defined for the first action object icon 455 in the workflow process 10. In an exemplary embodiment, in accordance with the first action object icon 455 in the workflow process 10, the form 445 is transmitted over a network 50 to the master center 110. The master center 110 receives the data from the end user 30 and formats the data into a forms submission request which is preferably transmitted to the master center 110. Preferably, the forms submission request is transmitted in an XML format. The forms submission request may also include direction as to the next step in the workflow process 10.

The master center 110 saves the form submission data in a database table that may be specifically created for the form. The form submission data may be available for access by an end user 30 any time during the execution of the workflow process 10.

Following execution of the action object icon 455 by an end user 30 or end users 30, the next action object icon 455 to be executed in the workflow process 10 is presented. The execution of the action object icons 455 in a workflow process 10 continues until all action object icons 455 in the workflow process 10 have been executed. Again, the master center 110 saves the form submission data received from each action object icon 455 executed in the workflow process 10 in a database table. The forms submission data may be accessed by a system analyst 40 with appropriate security clearance for auditing purposes, which include, but are not limited to: reviewing a record of all executed workflow processes, reviewing revisions to a form, and reviewing which system analyst 40 or end user 30 revised the form.

The terms and expressions that have been employed in the foregoing specification are used as terms of description and not of limitation, and are not intended to exclude equivalents of the features shown and described or portions of them. The scope of the invention is defined and limited only by the claims that follow.

1. A method for defining a workflow process, said method comprising the steps of:
(a) collecting a plurality of data
(b) defining at least one data record based on said plurality of data;
(c) allocating said at least one defined data record to at least one data file; and
(d) organizing said at least one data file into at least one form.

2. The method of claim 1, and further comprising saving said at least one data record at a master center.

3. The method of claim 2, and further comprising saving said at least one data record at said master center as an XML representation.

4. The method of claim 1, said step of defining at least one data record based on said plurality of data further including controlling how said plurality of data is input using user interface data selection techniques.

5. The method of claim 1, and further comprising the step of saving said at least one data file at a master center.

6. The method of claim 5, and further comprising the step of saving said at least one data file at said master center as an XML representation of at least one form.

7. The method of claim 1, and further comprising the step of saving said at least one form at a master center.

8. The method of claim 7, and further comprising the step of saving said at least one form as at least one action object icon.

9. The method of claim 1, further comprising the step of outputting a representation of said at least one form.

10. The method of claim 1, further comprising the step of formatting said at least one form into a format defined by a group consisting of:
(a) an end user; and
(b) a system analyst.

11. The method of claim 10, further comprising the step of saving said at least one formatted form on said master center.

12. The method of claim 1, and further comprising the step of developing a user interface to be used in connection with said workflow process.

13. The method of claim 12, said step of developing said user interface to be used in connection with said workflow process including developing a web-based user interface.

14. The method of claim 13, and further comprising the step of programming said web-based user interface in a programming language that is different from a programming language used to program said at least one data record, said at least one data files, and said master center.

15. A method for creating a workflow process, said method comprising the steps of:
(a) accessing a business logic editor located on a master center;
(b) presenting at least two action object icons on a user interface;
(c) accessing a canvas screen;
(c) selecting a first of said at least two action object icons;
(d) moving said first of at least two action object icon to said canvas screen;
(e) defining properties for said first of at least two action object icons;
(f) moving a second of said at least two action object icons to said canvas screen;
(g) defining properties for said second of at least two action object icons;
(h) linking said at least two action object icons to create a workflow process; and
(i) defining form processing actions by setting action object icon properties for said at least two action object icons.

16. The method of claim 15, wherein said business logic editor is a thin client application.

17. The method of claim 15, further comprising the step of accessing said master center using a web based user interface.

18. The method of claim 15, further comprising adjusting said workflow process to create and display at least one page boundary, said at least one page boundary including at least one horizontal page or at least one vertical page.

19. The method of claim 18, further comprising showing said page boundaries using at least one dotted line.

20. A method for executing a workflow process, said method comprising:
(a) inputting a request to access a workflow process to a master center;
(b) accessing said requested workflow process containing at least two action object icons;
(c) executing a first action object icon of said workflow process;
(d) saving said executed first action object icon on said master center;
(e) determining a second action object icon of said workflow process;
(f) executing a second action object icon of said workflow process;
(g) saving said executed second action object icon on said master center; and
(h) continuing to execute said action object icons of said workflow process until said workflow process is complete.

21. The method of claim 20, said steps of executing at least two action object icons of said workflow process further including accessing said at least two action object icons to review at least one form.

22. The method of claim 21, and further comprising the step of inputting data on said at least one form.

23. The method of claim 20, and further comprising the step of accessing said master center over a network using an end user.

24. The method of claim 23, wherein said end user is:
(a) a client computer;
(b) a user; or
(c) said user and said client computer.

25. The method of claim 20, and further including inputting an HTTP request into a client computer, said HTTP request being transmitted over a network to a master center;

26. A system for defining a workflow process, said system comprising:
(a) means for collecting a plurality of data;
(b) means for defining at least one data record based on said plurality of data;
(c) means for allocating said at least one defined data record to at least one data file; and
(d) means for organizing said at least one data file into at least one form.

27. A system for creating a workflow process, said system comprising:
(a) means for accessing a business logic editor located on a master center;
(b) means for presenting at least two action object icons on a user interface;
(c) means for accessing a canvas screen;
(c) means for selecting a first of said at least two action object icons;
(d) means for moving said first of at least two action object icon to said canvas screen;
(e) means for defining properties for said first of at least two action object icons;
(f) means for moving a second of said at least two action object icons to said canvas screen;
(g) means for defining properties for said second of at least two action object icons; and
(h) means for linking said at least two action object icons to create a workflow process.

28. A system for executing a workflow process, said system comprising:
(a) means for inputting a request to access a workflow process to a master center;
(b) means for accessing said requested workflow process containing at least two action object icons;
(c) means for executing a first action object icon of said workflow process;
(d) means for saving said executed first action object icon on said master center;
(e) means for determining a second action object icon of said workflow process;
(f) means for executing a second action object icon of said workflow process;
(g) means for saving said executed second action object icon on said master center; and
(h) means for continuing to execute said action object icons of said workflow process until said workflow process is complete.

29. A method for creating a workflow process, said steps comprising:
(a) receiving an HTTP request, said HTTP request being received from a network;
(b) providing access to a screen and at least two action object icons; and
(c) allowing at least two of said at least two action object icons to be moved to said screen and to be linked in a workflow process.

30. A system for performing a workflow process over a network, comprising:
(a) means for receiving an HTTP request from an end user;
(b) means for accessing a workflow processes based on said HTTP request from said end user.
